(19) United States
(12) Patent Application Publication
(10) Pub. No.: US 2024/0127010 A1
(43) Pub. Date: Apr. 18, 2024

(54) ADAPTIVE POWER STORAGE CIRCUIT FOR APPARATUS SUCH AS SMARTCARDS & METHOD OF OPERATING A POWER STORAGE CIRCUIT

(71) Applicant: FREEVOLT TECHNOLOGIES LIMITED, London (GB)

(72) Inventors: Victor DIAZ, London (GB); Vitor FREITAS, London (GB); Alison LLOYD, London (GB); Nigel WHITEHEAD, London (GB)

(21) Appl. No.: 18/277,422

(22) PCT Filed: Feb. 16, 2022
(86) PCT No.: PCT/GB2022/050420

§ 371 Date: Aug. 16, 2023

(30) Foreign Application Priority Data
Feb. 16, 2021 (GB) 2102133.2

(51) Int. Cl. G06K 7/10

(52) U.S. Cl. CPC G06K 7/10297

(57) ABSTRACT

A near field RF communications enabled device comprising: a coupler for connecting to a near field RF communications antenna for inductive coupling with an H-field provided from another near field RF communications enabled device in near field range, an adaptive energy storage comprising a plurality of energy stores and a controller configured to control charging of the adaptive energy storage so that the plurality of energy stores are charged sequentially from energy obtained via the coupler; wherein the controller is configured to provide, at the coupler, a signal configured to cause the another near field RF communications enabled device to increase or to maintain the H-field.

### TECHNICAL FIELD

The present disclosure relates to methods and apparatus, and more particularly to methods and apparatus for the storage of electrical energy in systems which may harvest power from intermittent sources, such as rectifier circuits such as those used in near field RF communications apparatus and the like.

### BACKGROUND

Smartcards, also known as chip cards, or integrated circuit cards (ICC), are increasingly prevalent. A wide variety of such pocket-sized cards with embedded integrated circuits are in use in a wide variety of applications. The most frequent uses of such cards relate to financial transactions, mass transit systems, and access control. Smart cards are made of plastic, generally polyvinyl chloride, but sometimes polyethylene-terephthalate-based polyesters, acrylonitrile butadiene styrene or polycarbonate. Reusable smart cards may also be made from paper. Such cards often incorporate an integrated circuit, IC, and some source of power such as a near field RF communications interface for powering the IC and providing data communications to and from it.

An IC device, herein called a chip, traditionally consists of a single semiconductor die which has a particular function and which is adapted to interact with other chips and components. For example, a traditional chip might be a microprocessor, a memory controller, or a memory array. IC systems may include two or more chips, as well as other electronic and electrical components, each attached to and interconnected through a mounting system such as a printed circuit board.

The ability of near field RF communications devices to be passively powered is a significant benefit. Some near field communicator chips also provide auxiliary power outputs. This can enable power harvested by the near field RF communicator to be used by other circuits.

Biometric enabled smartcards are based on providing a service depending on the validity of biometric data, such as a fingerprint. A common application is to selectively allow/deny access to the data stored on a near field RF communicator (sometimes called a “tag”) embedded in the smartcard dependent on validation/authentication of the biometric data. In order to make this system work, the tag must be hidden from the outside world until the fingerprint has been authenticated.

Next generation smartcards, such as biometric smartcards, need:
More power than standard smartcards
Power for longer than a basic NFC smartcard

On the other hand, some readers, especially in the access control market, don't emit a constant field, but instead a pulsed one; this is particularly evident when there is no corresponding card to communicate with, with the reader emitting only very short search pulses. This makes it very difficult to rely on power harvested from the reader to power biometric functions on the card, or other functions that precede communication.

This means that some kind of energy storage is needed for the time that the field is off, to allow for biometric capture, processing and verification.

The usual go-to solution is to use batteries (either rechargeable or primary), but this presents the following issues:
Environmental and recyclability problems which may be unacceptable for a mass-produced item such as a payment card or access control card.
Storage limitations (e.g. Lithium cell acceptable temperature range).
Finite life span of the product due to primary discharge or secondary aging.
If they are rechargeable, usually the admitted current for charging is around 1C (C being the capacity of the battery), which considering the very small size of the battery used (10-15 mAh is typical), most of the harvested power goes to waste, and so charging is inefficient.
Increased manufacturing complexity and cost

The provision of a reliable power supply in a system such as a smartcard therefore represents a particular problem.

### SUMMARY

Aspects and examples of the present invention are set out in the claims and aim to address technical problems such as those outlined above and related problems.

An embodiment provides adaptive energy storage, having a plurality of energy stores. A selected one of these energy stores is supplied with energy from an energy source in preference to the others. When the selected energy store is charged to a threshold level, the next of the energy stores is supplied with energy from the energy source to charge it up. The supply of energy to the charging energy store may be modulated (e.g. throttled) to inhibit any previously charged energy store(s) from discharging into the energy store which is being charged. The energy stored in the energy stores may be monitored, for example by sensing a voltage of the energy storage, and the supply of energy to the charging energy store may be modulated based on the sensed voltage. Alternatively, charging of each energy store may follow a schedule, which may be predetermined for example the supply of energy may be provided at a selected rate for a selected period of time.

Throttling of the supply of energy may be accomplished by any one of a variety of means—for example it may be done by controlling the current supplied to the energy store by the energy source. This may be done by modulating the current, for example by operating a controllable connection, which provides for current flow from the energy source to the energy store. This ‘throttling’ may be done so that the time average of current supplied to the energy store from the energy source is less than that associated with a voltage of the energy source and the impedance presented to the energy source by the energy store.

For example, the controllable connection may be modulated, e.g. switched intermittently, for example using a pulse width modulation. The duty cycle of such modulation may be controlled to vary, e.g. by the controller, so that the duty cycle increases as the amount of energy stored by the energy store which is being charged increases.

The energy stores may each comprise a capacitance, for example which may be provided by one or more individual capacitors.

In one example—a first capacitance may be connected at the output of the rectifier. Once the first capacitance is charged sufficiently to power a controller, the controller may switch on. In embodiments in which the charging of the energy stores is based on the level of energy stored (e.g. based on a sensed voltage) the controller may then begin monitoring the voltage at the rectifier output and/or the voltage across the first capacitance. Then it progressively connects further capacitance(s) in the same fashion until enough energy has been stored.

The controller may switch on further auxiliary functions of the smartcard. For example it may control an impedance matching circuit, connected to the antenna, by adjusting the impedance presented to the antenna so as to improve energy transfer to the smartcard from an H-field provided by another near field RF communications device. Such impedance matching steps may be done prior to complete charging of the energy storage, for example it may be done when just enough energy is stored to support the adaptive impedance matching. It may also be done prior to charging of any of the energy stores.

Once enough energy is stored in the bank of these capacitive energy stores, it may switch on a main controller, such as a microprocessor, which can control authentication functions of the smartcard to enable or inhibit operation of a near field RF communication chip according to the authentication. For example the controller may prevent operation of the communications chip until biometric (or other) verification has been successfully completed.

In an aspect there is provided a smartcard apparatus comprising:
means for obtaining a source of electrical energy from a near field RF communications antenna;
adaptive energy storage comprising a plurality of controllable connections and a plurality of energy stores wherein delivery of energy to each energy store from the source is controlled by a respective corresponding one of the controllable connections;
a controller connected for controlling each of said controllable electrical connections;

wherein the controller is configured to operate the controllable connections to charge the energy stores in a sequence.

In an aspect there is provided an adaptive energy storage apparatus comprising:
a coupling for connection to a source of electrical energy;
a plurality of controllable connections and a plurality of energy stores wherein delivery of energy to each energy store from the source is controlled by a respective corresponding one of the controllable connections;
   a controller connected for controlling each of said controllable electrical connections;
wherein the controller is configured to operate the controllable connections to charge the energy stores in a sequence.

The energy stores may comprise capacitors. The energy stores may be connected between the source of electrical energy and a reference voltage. The capacitors may each be connected to the reference voltage by a respective corresponding one of the controllable connections.

The controller may be configured to operate the controllable connections to charge a selected one of the energy stores to a threshold level while keeping others of the energy stores disconnected from the source of electrical energy. As noted above, the controller may sense the energy stored (e.g. by sensing a voltage of the energy stores) and may control the controllable connections based on this sensing. In some embodiments, the controller may operate the controllable connections according to a schedule, for example to charge each of the energy stores in the sequence in a selected time, which may be predetermined. The source may be a source of DC electrical energy, such as a rectifier.

The controller may be configured to operate the controllable connection to the selected one of the energy stores to reduce conducting operation of said controllable connection.

The controller may be configured to increase conducting operation of said controllable connection in accordance with charging of the selected one of the energy stores.

The controller may be configured to sense a voltage of the energy stores and to control conducting operation of said controllable connection based on the sensed voltage. Controlling conducting operation may comprise at least one of:
(a) controlling a switching cycle of said controllable connection; and
(b) controlling a current through said controllable connection.

The switching cycle may comprise a pulse modulation scheme such as at least one of: pulse width modulation (PWM) and pulse frequency modulation (PFM).

Controlling conducting operation based on the sensed voltage may comprise operating said controllable connection to maintain the sensed voltage above a selected threshold.

The controller may be configured to increase conducting operation of said controllable connection in response to an increase in the sensed voltage. For example it may increase conducting operation of said controllable connection in the event that the sensed voltage exceeds a threshold.

Increasing conducting operation of said controllable connection may comprise at least one of:
(a) providing a fully ‘on’ state of said connection; and
(b) providing at least one intermediate conducting state in which current through the connection is throttled—for example by switching of the connection e.g. by a pulse modulation such as PWM, PFM, PPM.

The controller may operate the controllable connection to charge another of the energy stores in the event that said fully ‘on’ state is provided. The fully ‘on’ state may comprise the controllable connection being latched into a conducting state.

Prior to said charging of each energy store, the controllable connection to that energy store may be kept switched off.

The apparatus may comprise an initiating energy store, connected to the source and arranged to power the controller. This initiating energy store may be permanently connected to the source, so that there is no need to operate any controllable connection in order to charge the initiating energy store.

The means for obtaining a source of DC electrical energy from a near field RF communications antenna may comprise a coupler for connecting the apparatus to a near field RF communications antenna for inductive coupling with an H-field provided from another near field RF communications enabled device in near field range,

wherein the controller is configured to provide, at the coupler, a signal configured to cause the another near field RF communications enabled device to increase or to maintain the H-field.

An aspect provides a near field RF communications enabled device comprising:
a coupler for connecting to a near field RF communications antenna for inductive coupling with an H-field provided from another near field RF communications enabled device in near field range,
an adaptive energy storage comprising a plurality of energy stores and a controller configured to control charging of the adaptive energy storage so that the plurality of energy stores are charged sequentially from energy obtained via the coupler;
wherein the controller is configured to provide, at the coupler, a signal configured to cause the another near field RF communications enabled device to increase or to maintain the H-field.

The signals may cause the another near field RF communications enabled device to increase or to maintain the H-field, such as it would in response to the presence of a near field device with which it is to communicate, for example by mimicking such a device. Such signals may comprise a request signal, for example according to a near field communications protocol, to which the another near field RF communications enabled device is configured to respond by increasing or to maintaining the H-field. These signals may also be referred to as “spoofing” signals in that they may be designed to “spoof” the another near field RF communications enabled device into acting as if it were communicating when in fact it may not be doing so. The foregoing types of signals may comprise at least one of: (a) variations in impedance, such as load modulation, and (b) electrical signals, such as might be provided by an active tag or an NFC chip acting in reader mode. Such signals may be provided by connecting the chip to the antenna and permitting it briefly to communicate, before interrupting the communication (e.g. by disconnecting the chip from the antenna) before data communication can be completed. This may be done by disconnecting the chip after a pre-determined time to “hide” the chip from the antenna.

The controller may be configured to trigger selected operations of an auxiliary circuit based on a characteristic of the energy storage.

The characteristic may comprise at least one of: (a) a number of the controllable connections in the fully ‘on’ state; (b) the number of the energy stores which are charged; and (c) a voltage of the energy storage.

The operations of the auxiliary circuit may comprise at least one of (a) an authentication function, such as verifying an identifier such as a biometric identifier; (b) a spoofing operation; and (c) an impedance matching operation.

An embodiment of the disclosure provides a smartcard blank for laminating into a smartcard, the smartcard blank comprising any apparatus described or claimed herein. An embodiment provides a smartcard comprising any apparatus described or claimed herein.

The controller may be configured to operate the controllable connections to charge a selected one of the energy stores to a threshold level while keeping others of the energy stores disconnected from the source of DC electrical energy.

An embodiment provides a near field RF communications enabled device comprising any one or more of the apparatus described or claimed herein wherein the device is configured to perform near field RF communication functions and further comprises an auxiliary circuit for performing an auxiliary function of the smart card, wherein the auxiliary function is triggered in the event that at least one of (a) a voltage of the energy storage exceeds a threshold level and (b) a threshold number of the energy stores are charged. For example, the controller may determine how many of the energy stores are charged (or assumed to be charged) based on the number of controllable connections which are held in the fully ‘on’ state.

In an aspect there is provided a method of controlling a near field RF communications enabled device, the method comprising:
rectifying an alternating electrical signal obtained by inductive coupling with another near field RF communications enabled device in near field range to provide a source of electrical energy having a DC source voltage; and
operating the controllable connections to charge the energy stores in a sequence.

In an aspect there is provided a method of operating a near field RF communications enabled device, the device comprising:
a coupler for connecting to a near field RF communications antenna for inductive coupling with an H-field provided from another near field RF communications enabled device in near field range,
an adaptive energy storage comprising a plurality of energy stores and a controller configured to control charging of the adaptive energy storage so that the plurality of energy stores are charged sequentially from energy obtained via the coupler;
the method comprising providing, at the coupler, a signal configured to cause the another near field RF communications enabled device to increase or to maintain the H-field, and using the H-field to charge the adaptive energy store before communicating with the another near field RF communications enabled device.

The signal may comprise a spoofing signal configured to cause the another near field RF communications enabled device to act as if it is communicating data thereby to charge the adaptive energy storage. The method may comprise rectifying an alternating electrical signal obtained by inductive coupling with another near field RF communications enabled device in near field range to provide a source of electrical energy having a DC source voltage; and operating controllable connections of the adaptive energy storage to charge energy stores of the adaptive energy storage in a sequence.

In these and other embodiments a controller may be configured to operate an auxiliary circuit of the device to trigger selected operations of an auxiliary circuit based on a characteristic of the adaptive energy storage, and then to control said communicating with the another near field RF communications enabled device based on said selected operations. The selected operations of the auxiliary circuit may comprise at least one of (a) an authentication function, such as verifying an identifier such as a biometric identifier; and (b) an impedance matching operation. Controlling said communicating may comprise preventing said communication in the event that an authentication function fails and/or communicating a result of the authentication function to the another near field RF communications.

The methods described above may comprise operating the controllable connections to charge a selected one of the energy stores to a threshold level while keeping others of the energy stores disconnected from the source of electrical energy. The source may be a source of DC electrical energy, such as a rectifier.

Such methods may comprise operating the controllable connection to the selected one of the energy stores to reduce conducting operation of said controllable connection.

Such methods may comprise increasing conducting operation of said controllable connection in accordance with charging of the selected one of the energy stores.

Such methods may comprise sensing a voltage of the source; and
operating a selected one of the controllable electrical connections to control flow of energy to a selected one of the energy stores based on the voltage of the source.

The selected controllable connection may be operated so as to maintain a DC component of the source voltage above a selected threshold voltage by limiting the power provided from the source to the first energy store.

Operating the selected controllable electrical connection may comprise selecting a duty cycle of the first controllable connection based on the voltage of the energy store. The duty cycle may be increased as the sensed voltage increases.

Such methods may comprise operating a second controllable electrical connection to connect a second energy store to the source of electrical energy for charging and to the first energy store, while powering said auxiliary circuits of the device from the first energy store.

Such methods may comprise providing to another near field RF communications enabled device in near field range a signal configured to cause the another near field RF communications enabled device to provide energy to the near field RF communications enabled device. This may be done without performing near field RF communications. As noted above, the signal configured to cause the another near field RF communications enabled device to provide energy to the near field RF communications enabled device may comprise a request signal or a “spoofing” signal, and may be provided by load modulation on the near field antenna, or by the provision of active electrical signals to the antenna. These and other methods of causing the another near field RF communications enabled device to provide energy may be accomplished by connecting the chip (or a decoy chip) to the antenna for a short period before interrupting the communication, e.g. by disconnecting the chip (or decoy chip).

The means for obtaining a source of electrical energy may comprise electrical circuitry such as an electrical connection to a rectifier. The electrical circuitry may comprise the rectifier, but this may also be provided separately.

An aspect provides a smart card comprising an antenna, a near field RF communications chip and an auxiliary circuit, separate from the chip, and an adaptive energy storage such as any of those described or claimed herein, wherein the adaptive energy storage is coupled to the antenna by a rectifier and arranged for storing electrical energy obtained by the rectifier from the antenna. The apparatus may comprise a controller arranged to provide power from the energy store to the auxiliary circuits for performing an auxiliary function of the smartcard, such as an authentication function. The authentication may comprise a biometric authentication, such as may be provided by a fingerprint sensor. The auxiliary circuit may comprise biometric sensing circuits (such as a fingerprint sensor) and circuitry such as a controller for performing sensing operations and/or for performing authentication of the sensed biometric data—for example—by collecting a fingerprint and then comparing the sensed fingerprint with stored data for authentication. These biometric sensing circuits may be powered in whole or in part by the adaptive energy storage. The controller may be configured selectively to enable communication between the antenna and the near field RF communications chip based on an output from the auxiliary circuits, for example based on the authentication function.

Apparatus of the present disclosure may comprise an RF switch such as any described herein wherein the RF switch is operable selectively to connect the communications chip to the antenna and is arranged to be controlled by the auxiliary circuit so that the auxiliary circuit can selectively enable and disable the chip by operating the switch. For example the auxiliary circuit may enable or disable the chip based on authentication, such as authenticating biometric data.

A variety of splitters are described herein, but it will be appreciated in the context of the present disclosure that whilst these types of splitters have particular advantages, other types of splitting circuits may be used.

Some splitters described herein may comprise a first port connected to the antenna coupling and having a first input impedance; a second port connected to the first port and configured to provide a first part of the alternating electrical signal to the chip via the switching circuit; and a third port connected to the first port and configured to provide a second part of the alternating electrical signal to auxiliary circuit. Such splitters may be configured to maintain the first input impedance so that: the output impedance of the second port is maintained in the event of fluctuations in the output impedance of the third port; and the output impedance of the third port is maintained in the event of fluctuations in the output impedance of the second port. The splitter may be configured to provide, at the first port, variations in electrical load corresponding to the variations in electrical load at the second port thereby to enable the chip to perform near field RF communications via load modulation.

### BRIEF DESCRIPTION OF DRAWINGS

Embodiments of the disclosure will now be described in detail, by way of example only, with reference to the accompanying drawings, in which:

FIG. 1 shows a smartcard apparatus comprising an adaptive power storage apparatus according to the present disclosure;

FIG. 2 shows a further example of a smart card apparatus such as that illustrated in FIG. 1;

FIG. 3 is a flow chart illustrating a method of operating apparatus such as that shown in FIG. 1 and FIG. 2;

FIG. 4 shows a diagram of a splitter for use in such apparatus;

FIG. 5 shows a diagram of another splitter; and

FIG. 6 shows a further smartcard apparatus comprising a splitter and rectifying circuit and an adaptive energy storage according to the present disclosure.

In the drawings like reference numerals are used to indicate like elements.

### SPECIFIC DESCRIPTION

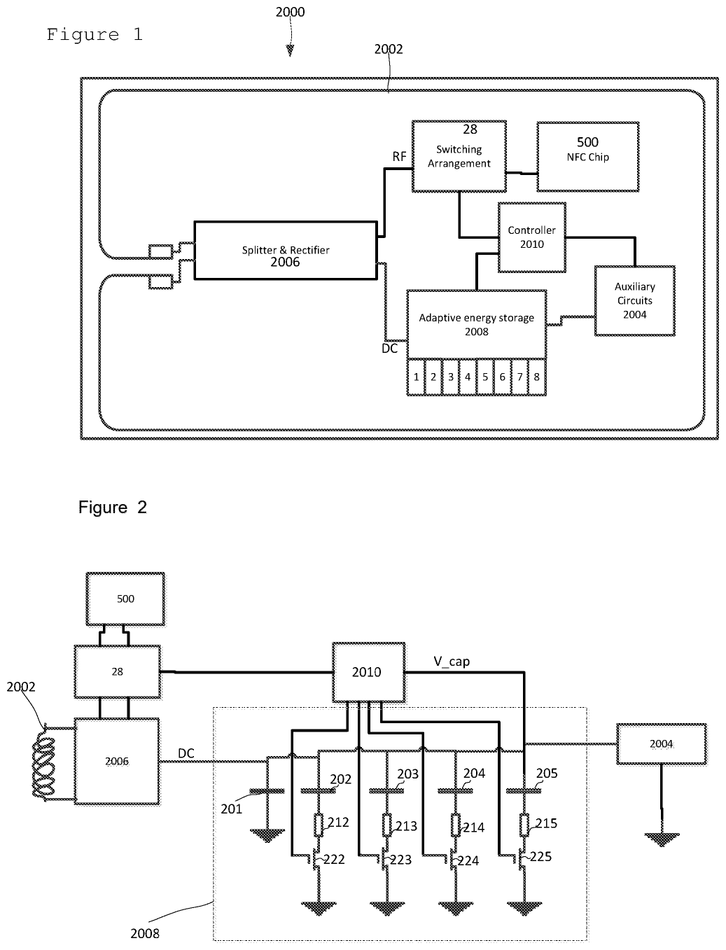

FIG. 1 shows a functional block diagram of a smartcard 2000. The smartcard 2000 comprises a near field antenna 2002, a near field RF communications chip 500, a splitter and rectifier 2006, and circuitry for controlling the chip. The circuitry for controlling the chip comprises a switching arrangement 28, adaptive energy storage 2008, and auxiliary circuits 2004 separate from the chip 500.

The splitter and rectifier 2006 is connected to the antenna 2002, and comprises a DC output connected for providing DC electrical energy to the adaptive energy storage 2008, and an RF output for enabling the near field RF communications chip 500 to perform near field RF communication via the antenna 2002.

The DC output of the splitter and rectifier is connected, via the adaptive energy storage 2008, to the auxiliary circuits 2004. The RF output is connected to the chip 500 via the switching arrangement 28. A controller 2010 is connected to the adaptive energy storage 2008, to the switching arrangement 28, and to the auxiliary circuits 2004.

The adaptive energy storage 2008 comprises a plurality of energy stores 1-8 and controllable electrical connections for connecting the energy stores 1-8 to the splitter and rectifier 2006. It will be appreciated in the context of the present disclosure that although 8 energy stores are shown this is merely an example and potentially any number of energy stores may be provided. In addition, although the energy stores are shown as being of equal size this is merely schematic and should not necessarily be taken to imply that they are of equal energy storage capacity.

The controller 2010 comprises logic circuits connected for operating the controllable electrical connections of the storage 2008 for individually connecting selected ones of the energy stores 1-8 so that they can be charged from the splitter and rectifier 2006 in a sequence selected by the controller. Connecting the energy stores also enables them to provide energy to the controller 2010 itself and/or to the auxiliary circuits 2004. The controller 2010 may also be configured to control the connection to individual selected ones of the energy stores so as to select the rate at which each energy store is charged—e.g. so as to provide at least one intermediate charging rate. Such an intermediate charging rate may be intermediate between a zero (completely ‘off’) charging state and a completely ‘on’ state in which the selected energy store is simply connected to the splitter and rectifier 2006. The controller is also configured to control these controllable connections so that the energy stores 1-8 are charged in a sequence, in which a selected one of the energy stores is charged while other (e.g. uncharged) energy stores are kept disconnected.

The controller 2010 is connected to the auxiliary circuits 2008, and is configured to control the switching arrangement 28 based on a signal provided from the auxiliary circuits—e.g. to enable or to inhibit operation of the chip 500.

The controller 2010 may also be configured to determine the number of energy stores which are charged up (e.g. based on the number which are in a completely ‘on’ state), and to trigger a selected function of the auxiliary circuits based on this number and/or based on the voltage stored on the energy stores, which may be indicative of an amount of energy stored.

The switching circuitry 28 is coupled between the chip 500 and the splitter and rectifier 2006. It is also connected to the controller 2010. The switching circuitry 28 is selectively switchable, by the controller, between (a) a first state in which the near field RF communications chip 500 is connected to communicate via the antenna 2002; and (b) a first state in which the near field RF communications chip 500 is inhibited from communicating via the antenna 2002—e.g. is disconnected from the antenna or communications are impeded—for example by noise injection.

In operation, when a near field RF signal is received by the antenna 2002 of the smart card from a near field RF communications device in near field range, an RF electrical signal is induced in the antenna and provided from the antenna to the splitter and rectifier 2006.

The splitter and rectifier 2006 uses this RF electrical signal to provide DC electrical energy to the adaptive energy storage 2008, which charges up an initial energy store 1. When the initial energy store is charged to an operating voltage which can be used to power the controller 2010, the controller 2010 switches on.

The controller 2010 then operates the adaptive energy storage 2008 so that a selected one 2 of the uncharged energy stores 2-8 is charged while the uncharged energy stores 3-8 are kept switched off. Once the selected energy store 2 has been charged, it is kept connected for providing energy to the auxiliary circuits 2004. The controller then selects the next one 3 of the uncharged energy stores 3-8 for charging, and operates its controllable connection to charge it up.

While that next energy store 3 is being charged, the remaining uncharged energy stores 4-8 are kept switched off and the already charged energy stores 1-2 are used for providing energy to the auxiliary circuits 2004 and/or to the controller 2010.

This process continues progressively, in sequence, until enough of the energy stores are charged to perform a function of the auxiliary circuits 2008. The sequential approach to charging outlined above may enable a large capacity energy storage to be charged progressively.

The controller 2010 may then trigger operation of the auxiliary circuits 2004 (e.g. based on the number of energy stores 1-8 which are charged up). The auxiliary circuits 2004 are then able to perform an auxiliary function of the smartcard, such as an authentication process—e.g. based on obtaining authentication data and comparing it to a stored comparator. For example, the authentication data may be a biometric identifier, such as a fingerprint. For example, the auxiliary circuits may comprise a fingerprint sensor. The comparator may comprise appropriate stored data for comparison with the authentication data for verifying the identity of a person.

Until this authentication process is complete, the switching circuit 28 may inhibit the near field RF communications chip 500 from performing near field RF communications. Based on a signal from the auxiliary circuits 2004 (e.g. indicating the outcome of the authentication process) the controller 2010 may determines whether or not to enable the near field RF communications chip 500 to perform near field RF communications.

In the event that the chip is to be allowed to communicate, the switching circuit 28 is switched into its second state to provide the RF electrical signal from the splitter & rectifier 2006 to the near field RF communications chip 500.

It can thus be seen that operation of the switching circuit 28 can inhibit the chip from performing near field RF communications e.g. until a function of the auxiliary circuit 2004 has been completed and an authentication/control process has indicated that the chip 500 should operate.

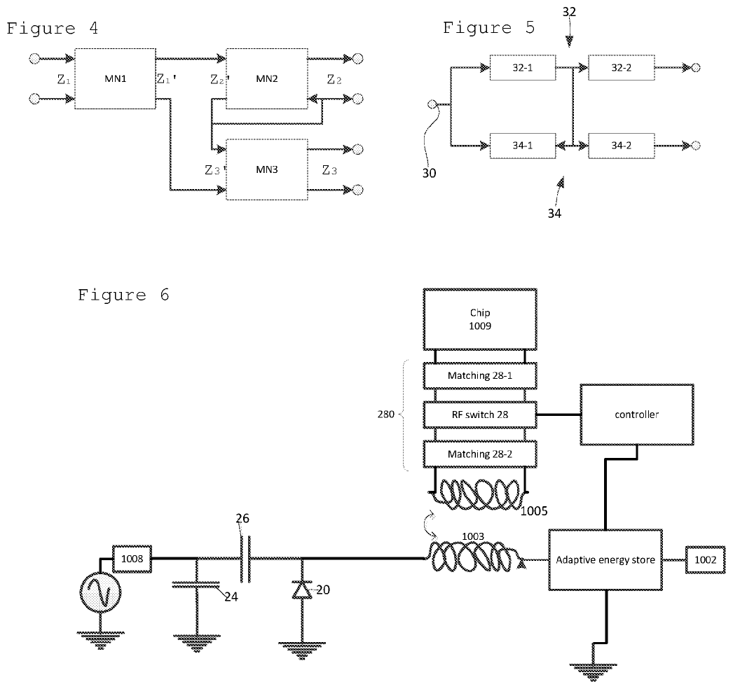

The above functionality may be implemented in a variety of different ways. The implementation details of a few possibilities will be described in detail below. Examples of appropriate splitter circuits are illustrated in FIG. 4, FIG. 5, and FIG. 6, but other splitters may be used. The rectifier component of the splitter and rectifier 2006 described herein may be provided by any appropriate rectifier.

FIG. 2 shows a circuit diagram of one possible implementation of a system such as that described with reference to FIG. 1.

As with the arrangement shown in FIG. 1 a near field communications antenna is connected to a splitter and rectifier 2006. The splitter and rectifier 2006 is connected by a switching arrangement 28 to a near field RF communications chip 500. A DC output from the splitter and rectifier is connected to an adaptive energy storage 2008, which is connected to power a controller 2010 and auxiliary circuits 2004. The controller 2010 is also connected for controlling the adaptive energy storage 201.

The adaptive energy storage 2008 illustrated in FIG. 2 comprises a capacitor 201 connected between its DC input and ground. As mentioned elsewhere, the capacitors shown in the drawings are merely schematic representations of a capacitance. They may be provided by individual capacitors, or by the series and/or parallel connection of a number of capacitors. However they are provided, this capacitor 201 provides a first energy store, arranged to be charged passively by any DC current from the rectifier and splitter 2006.

It also comprises a plurality of further capacitors 202, 203, 204, 205. Each further capacitor 202, 203, 204, 205, is connected between the DC input and ground. Each in series with a corresponding resistance 212, 213, 214, 215, and a corresponding voltage controlled impedance 222, 223, 224, 225. Each such voltage controlled impedance comprises a conduction path between two main terminals which is operable to be controlled by a voltage applied to a control terminal of the VCI. A first plate of each of the further capacitors 202, 203, 204, 205 is connected to the DC input, whereas a second plate of each of them is connected to ground by the series connection of a corresponding resistance 212, 223, 224, 225 and the conduction path of a corresponding one of the voltage controlled impedances 222, 223, 224, 225. The control terminal of each of the voltage controlled impedances (VCIs) 222, 223, 224, 225 is connected to be controlled by the controller 2010.

The controller 2010 comprises control logic, such as a microprocessor, operable to provide control signals for controlling the VCIs 222, 223, 224, 225. It is configured to operate these VCIs to provide the sequential charging described above with reference to FIG. 1. In addition, it may be configured to modulate operation of these VCIs to control the rate at which each individual energy store 202, 203, 204, 205, is charged in that sequence. The controller may thus control the connection to individual selected ones of the energy stores so as to provide at least one intermediate charging rate for the corresponding energy store—either by intermittent switching of the VCIs, or by control of their impedance to modulate the current drawn by the energy stores 202, 203, 204, 205 from the DC input to the adaptive energy storage.

In operation, when a near field RF signal is received by the antenna 2002 of the smart card from a near field RF communications device in near field range, an RF electrical signal is induced in the antenna and provided from the antenna to the splitter and rectifier 2006.

The splitter and rectifier 2006 uses this RF electrical signal to provide DC electrical energy to the adaptive energy storage 2008, which charges up the first capacitor 201 to provide an initial energy store. When the voltage on this initial energy store reaches a voltage sufficient to power low level functionality of the controller 2010, the controller 2010 switches on and begins to control the controllable connections provided by the VCIs 222, 223, 224, 225 so as to charge each of the further capacitors in turn.

The controller 2010 then begins charging the second capacitor 202, and operates the corresponding VCI 222 so that the time average of the current drawn from the DC input by the second capacitor is relatively low as compared to the current which would be drawn if the connection to the capacitor was simply switched on. The controller 2010 may operate this VCI 222 so that the time average of the current drawn from the DC input may be controlled so as not to cause the first capacitor 201 to discharge, while the first capacitor 201 can continue to provide power for the controller 2010. This may be done by applying a modulation such as PWM (pulse width modulation) control to the VCI 222. The controller 2010 may then gradually increase the current drawn, e.g. by increasing the duty cycle of the PWM applied to the VCI 222. Thus, as the voltage on the capacitor increases, and so the current which would be drawn by the series connection of the capacitor 202, resistor 212, and VCI 222, would otherwise decrease, the duty cycle of the VCI is increased by the controller. Once the capacitor 222 is charged to a threshold level (such as the operating voltage) the VCI 222 may be held (e.g. latched) into an ‘on’ state).

The controller 2010 may then begin charging the next capacitor 203 in the same way by operating the corresponding VCI 223 so that the duty cycle of the connection used to charge the capacitor 203 gradually increases from an initial state in which the connection is completely off, to a final state in which the duty cycle is at a maximum (e.g. completely on). The controller may be configured so that the duty cycle, and/or the rate at which the duty cycle increases may be chosen based on the DC voltage provided from the splitter and rectifier 2008. This may be sensed based on the voltage, V_cap, provided from the adaptive energy storage 2008 to the controller 2010.

In these and other embodiments of the disclosure, the time average of the current drawn from the DC input may be controlled so as not to cause the first capacitor 201 and second capacitor 202 to discharge, while the first capacitor 201 and the second capacitor 202 continue to provide power for the controller 2010. Whether this or other constraints are applied, the controller 2010 can charge each of the capacitors 202, 203, 204, 205 in a sequence in which each is charged to a threshold level before the next in the sequence begins charging. This may be done by selecting each controllable connection in turn, gradually increasing the duty cycle of its operation to conduct until the corresponding capacitor is charged up, at which point the connection is maintained in an ‘on’ state.

A variety of different implementations are contemplated.

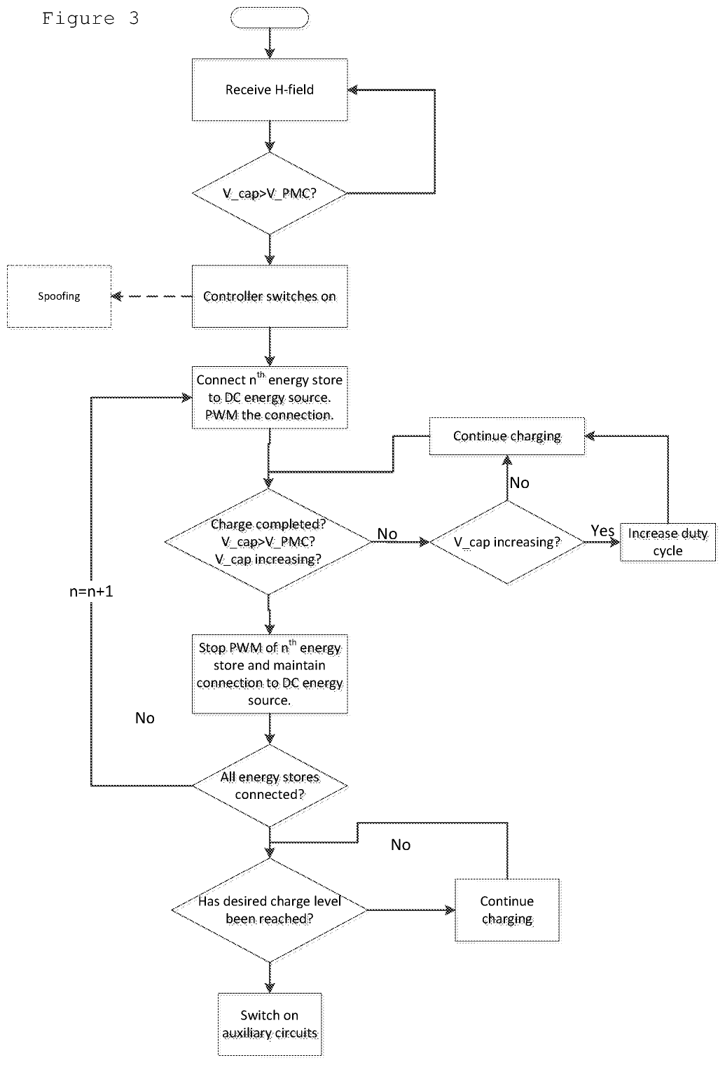

A first method of operating an apparatus such as that illustrated in FIG. 1 is illustrated in the flow chart shown in FIG. 3.

As illustrated, when the antenna 2002 is present in an H-field provided by a near field RF communications device such as a reader, the received H-field generates an alternating RF signal, which is rectified by the splitter and rectifier 2006 to provide a source of DC current to the adaptive energy storage 2008.

The first capacitor 201 of the adaptive energy storage is charged from this DC current until the voltage on this capacitor 201, V_cap, reaches a threshold level, V_PMC. During this phase of operation, the VCIs 222, 223, 224, 225, are switched off so that the capacitors 202, 203, 204, 205 do not draw current from the splitter and rectifier 2006. When V_cap reaches the threshold, V_PMC, the controller 2010 switches on. This threshold V_PMC may be set slightly higher than the minimum requirement for operation of the controller 2010 to enable the controller to continue to function in the event that the first capacitor discharges slightly.

The controller 2010 then begins to operate the first VCI 222 by providing a series of pulses to the control terminal of the VCI 222. Each pulse switches the VCI 222 into a conducting state which causes the capacitor 202 to draw current from the DC input of the adaptive energy storage 2008. The pulses may comprise a waveform, such as a square wave, having a selected frequency and a selected duty cycle. The frequency of the waveform may be on the order of 50 Hz to 10 MHz, but other frequencies may be used according to the capabilities of the controller 2010 and/or the characteristics of the VCIs.

The controller determines whether charging of the capacitor 202 has been completed by sensing the voltage V_cap and determining whether this voltage meets a first charging condition, for example whether charging has completed. The controller may be configured to sense whether charging has completed in the event that V_cap is (a) greater than a threshold operating voltage, V_PMC, and (b) also increasing. Either or both of these two conditions may be used, and different criteria and/or thresholds may be applied at different stages.

In the event that this first charging condition is met, e.g. the capacitor 202, the VCI 222 is held in an ‘on’ state (100% duty cycle) so that the capacitor that was being charged is simply connected to the DC energy source.

In the event that this first charging condition is not met, e.g. the capacitor 202 is not fully charged, the controller may then determine whether a second charging condition is met, for example whether or not V_cap is increasing. In the event that this condition is met, the controller may increase the duty cycle of the VCI 222. Charging is then continued until the first charging condition is checked again, and the cycle described above continues until the first charging condition is met and the capacitor that was being charged is simply connected to the DC energy source.

The controller then determines whether the required number of energy stores have been switched on (e.g. connected with 100% duty cycle). If not, the controller selects the next of the capacitors 203 and repeats the charging process. Once the required number of energy stores have been charged, the controller may determine whether the stored voltage V_cap is sufficiently high. If the voltage is high enough (and a sufficient number of capacitors have been charged) the controller triggers operation of the auxiliary circuits.

In some embodiments the controller may perform one or more pre-configured steps in the event that it senses a corresponding condition is satisfied. For example, the controller may be configured so that in the event that it senses that the voltage V_cap is greater than a first threshold—e.g. V_cap>Vstart, it operates the VCI to connect the first controllable energy store and controls the VCI using a modulation scheme such as PWM. Then, in the event that a second condition is satisfied, for example V_cap being greater than a second threshold and/or the voltage V_cap is increasing the conducting operation of the connection may be increased (e.g. to as much as 100%, in which the connection is left ‘on’.)

The controller may also be configured so that, once a selected number of energy stores have been charged it may control operation of the auxiliary circuit based on the number of energy stores and optionally further based on the voltage. Fore example, it may be configured to determiner whether a selected number of energy stores (such as all of the energy stores) have been “charged” in the sense of being in the fully ‘on’ state and, in the event that they are, it may continue charging the energy storage until a third threshold voltage is reached, and may only trigger selected functions of the auxiliary circuit when this condition is fulfilled.

This may have the advantage that the energy stores can be gradually switched into an on-state in sequence whilst holding the voltage at a level which is efficient for operation of the rectifier. Then, once all of the energy stores are ‘on’ it may begin charging further to increase the voltage until the voltage is sufficient to execute a given auxiliary function.

In another possibility, the system operates without voltage sensing. Instead, once the voltage on the first capacitor is sufficient to switch on the controller, the controller begins operating the controllable connection to the first energy store according to a predetermined schedule—e.g. to increase the conducting operation of its controllable connection over time (such as by increasing the duty cycle of a pulse modulation). This may be done in a sequence of steps (e.g. to increase by a step at some predetermined later time which may be indicated by a counter, such as an internal clock of the controller).

The controller may also be configured to begin a further charging operation e.g. by switching the controllable connection of the first energy store into a fully ‘on’ state and/or by beginning to operate the controllable connection of a second energy store to charge that second energy store.

This same sequence may then be repeated at a set of further predetermined times, until the clock indicates that a sufficient number of the energy stores are charged.

Once all the banks have been switched into the ‘on’ state the controller may be configured to wait a further time before activating the auxiliary circuit for the reasons explained above—e.g. to allow the voltage of the energy storage to continue to charge to a level suitable for the auxiliary function.

One possible control scheme has been outlined above, but other possibilities are contemplated.

In one possibility, during the charging of each capacitor, the controller 2010 increases the duty cycle from a pre-set initial level to a final level in a predetermined time. For example the duty cycle may increase at a predetermined rate. The duty cycles used may comprise one or more discrete duty cycle levels, intermediate between the ‘off’ state of zero duty cycle and the fully ‘on’ state of 100% duty cycle.

In some possibilities the controller may select the duty cycle based on the voltage, V_cap, so that in the event V_cap reduces during charging of one of the energy stores 202, 203, 204, 205, the duty cycle of the corresponding controllable connection 222, 223, 224, 225, is also reduced.

In another possibility, during the charging of each energy store 202, 203, 204, 205, the controller 2010 may increase the duty cycle from a pre-set initial level at a rate of increase selected based on the voltage V_cap. Thus, if V_cap is high, the controller will increase the duty cycle more quickly but reduce the rate of increase, or decrease the duty cycle, in the event that charging the capacitors causes the voltage, V_cap to drop.

The voltage V_cap may be sensed at particular times—for example it may be sensed at a series of intervals, such as provided by a sequence of samples. At least some of these samples may be taken during PWM pulses (e.g. when the VCI for the capacitor being charged is actually switched on). The voltage V_cap may be determined based on a time average of these samples (e.g. according to a recursive method, such as a sliding window).

Other control schemes may also be used.

According to any of the above schemes—the controller may thus be operated so that once the initial energy store is charged up, the second energy store is charged. This may be done by modulating the controllable connection to the second energy store 2. Once the second energy store 2 has been charged, the controllable connection is held fully ‘on’ (e.g. in a maximum conducting state), so that both the first energy store 1 and the second energy store together are connected together and operate as a combined energy store for the apparatus as a whole.

The controller then operates to control a controllable connection to a third one of the energy stores 3 in the same way until it is charged sufficiently, at which point it is connected to the first and second energy stores 1, 2. This mode of operation continues in sequence until sufficient energy is stored in the energy storage to permit operation of the auxiliary circuits 2004. The controller 2010 may determine whether or not sufficient energy is stored based on the number of energy stores 1-8 which have been charged to the operating voltage. Accordingly, the controller may be configured to provide control signals for operating one or more functions of the smart card based on the number of energy stores that have been charged to threshold. Examples of the functions which may be controlled in this way include obtaining data for example from a memory and/or via an interface such as an input interface for obtaining data input by a user of the card or a biometric interface for sensing a biometric identifier of the user. Examples of biometric data include identifiable skin contour data, such as fingerprints, image data, and audio files. Other examples of input data include alphanumeric data such as passwords and PIN numbers. Other examples of the functions which may be controlled in this way include operating a display such as an e-ink display, performing wireless communication by a non-near field method such as Bluetooth, and/or providing visual output to a user, such as by operating an LED. Other examples of the functions which may be controlled in this way include obtaining other identity proofs, e.g. by querying a blockchain, performing a cryptographic verification calculation, performing a pre-process to prepare for some sort of communication, e.g. preparing cryptographic tokens, generating a secure token such as a Dynamic Card Verification Value (DCVV), unlocking a secure data store and so forth.

In some embodiments the controllable connection to an energy store may be held fully ‘on’ before that energy store is fully charged. For instance, when the charge is 0%, a duty of 20% may used until charge reaches 30%, then a duty cycle of 50% is used, until charge reaches 60%, then duty 70% is used, until charge reaches 80%, then fully on is used until it charges to 100%. It will be appreciated in the context of the present disclosure that in this context 100% may mean simply 100% of target threshold to start charging the next cap bank. It will also be appreciated that the foregoing percentages are merely examples, and any sequence of thresholds may be used to provide a corresponding sequence of duty cycle operations.

The ground connections referred to herein may be provided by any appropriate reference voltage connection, such as a virtual earth. Typically the VCIs comprise NMOS FETs but any voltage controlled impedance may be used. The examples described above have been set out with reference to a smartcard. It is however appreciated in the context of the present disclosure that the adaptive energy store described herein may be used in a variety of other circumstances in which energy must be obtained and stored. The disclosure finds particular utility in miniaturised or hand portable (e.g. pocket sized) devices.

Near field communication in the context of this application may be referred to as near-field RF communication, near field RFID (Radio Frequency Identification) or near field communication. The range of such devices depends on the antenna used but may be, for example, up to 1 meter. The precise range may depend on transmit power, and modulation scheme.

As noted above, a variety of different splitting circuits may be used. A first example of a splitter is illustrated in FIG. 4, and a second in FIG. 5. Yet a third example is provided in FIG. 6, albeit in somewhat different topology. It will be appreciated from this disclosure however that a variety of different splitting circuits may be used and the principles of the present disclosure are not limited to one specific splitting topology. Typically however in the most advantageous systems the splitter is arranged to inhibit variations in the electrical load provided by the auxiliary circuit from affecting the load at the antenna. In other words, the splitter is arranged so that variations in the load associated with the auxiliary circuit are decoupled from the electrical load (impedance) presented at the smartcard antenna. This may be achieved by a network of impedances, such as a network of lumped components configured to provide such functionality.

FIG. 4 illustrates one such example which comprises a matching network having three stages, a first stage is provided by an antenna matching network, MN1, a second stage by a rectifier matching network, MN2, and a third stage by a communications chip matching network, MN3.

The antenna matching network MN1 has an input port comprising two input connections, and an output comprising two output connections. Likewise, the chip matching network and the rectifier matching network each have an input port comprising two input connections, and an output port comprising two output connections.

The two input connections of the antenna matching network can be connected to an antenna, which can provide an alternating electrical signal to the splitter. The first output connection of the antenna matching network, MN1, is connected to the first input connection of the rectifier matching network, MN2, whereas the second output connection of the antenna matching network, MN2, is connected to the second input connection of the chip matching network, MN3. The second input connection of the rectifier matching network, MN2 is connected to the first input connection of the chip matching network, MN3, and to the second output connection of the rectifier matching network, MN2.

The antenna matching network MN1 comprises a network of passive components, having some impedance such as a reactive impedance, such as capacitance and/or inductance. The antenna matching network may be arranged to provide an input impedance, Z1, which matches the output impedance of a near field RF communications antenna. It may have an output impedance Z1′. Likewise, the chip matching network and rectifier matching network may also each comprise a network of such passive components. The input impedance of the chip matching network may be Z2′, and its output impedance Z2. The input impedance of the rectifier matching network may be Z3′, and its output impedance Z3. In an embodiment, the impedance Z1 may be consist essentially of an impedance with a positive imaginary part, while Z2 and Z3 may each consist essentially of complex impedance with either a positive or a negative imaginary part. The impedance Z1′ may be equal to the conjugate of the sum of the impedances Z2′ and Z3′. The ratio of the real part of Z2′ to Z3′ may define the ratio of the split of input power from the antenna to the output connections of the chip matching network and the rectifier matching network.

FIG. 5 shows a functional block diagram of another example of a splitter for use in the apparatus of FIG. 1. The splitter shown in FIG. 5 has an input leg 30 for connection to the antenna. The input leg 30 is connected by a bifurcated electrical conduction path to two output arms 32, 34. The first output arm 32 comprises an input stage 32-1 and an output stage 32-2, which are connected together in series. Likewise, the second output arm 34 also comprises an input stage 34-1 and an output stage 34-2.

The input stage 32-1 of the first arm 32 is connected between the input leg 30 and the output stage 32-2 of the first arm 22. The input stage 34-1 of the second arm 34 is connected between the input leg 30 and the output stage 34-2 of the second arm 34. The connection between the input stage and the output stage of the first arm 32 may be connected, e.g. by a resistor (not shown) or other pure real impedance, to the connection between the input stage 34-1 and the output stage 34-2 of the second arm 34.

The input stages and output stages of the two arms 32, 34 may each comprise networks of passive, e.g. reactive, components such as inductors and capacitors arranged to provide a phase shift to the input signal. These may be lumped components. The phase shift provided by the input stage 32-1, 34-1 of each arm 32, 34 may be equal to that provided by the input stage of the other arm 34, 32. Also, the phase shift provided by the output stage of each arm may be equal to that provided by the output stage of the other arm. These stages may be arranged as either high pass filters, or low pass filters. Significantly, the use of such structures may reduce changes in the output impedance of one arm due to changes in the load/impedance presented at the output of the other arm. By selecting the impedance of these different stages appropriately, the power of the alternating electrical signal received from the input leg may be divided between the two arms according to a selected ratio, R.

The division of power between the first arm and the second arm may be controlled by selecting the ratio of the impedance of the input stage of the each arm relative to the output stage of that arm, and by selecting the ratio of the impedance of the input stage of the first arm to the impedance of input stage of the second arm. For example, a ratio of power division, R, may be provided between a ‘main branch’ arm which takes more of the power from the input leg than a ‘secondary branch’ arm. To achieve this, the magnitude of the impedance of the input stage of the ‘main branch’ arm may be 1/R of the impedance of the input stage of the ‘secondary branch’ arm. The ‘main branch’ arm output stage may have an impedance equal to the ‘main branch’ arm input stage divided by the square root of (1+R). The ‘secondary branch’ output stage may have an impedance equal to the ‘main branch’ arm input stage divided by the square root of (R*(1+R)). The splitter 902 shown in FIG. 5 is illustrated as being single ended, but it will be appreciated in the context of the present disclosure that differential embodiments may also be provided. Near field RF communicators may be actively powered, that is have an internal or associated power source, or passively powered, that is derive a power supply from a received magnetic field. Generally an RF transceiver will be actively powered while an RF transponder may be passively or actively powered.

FIG. 6 shows a circuit for control of a near field RF communications chip for a smartcard.

The circuit comprises an input connection 1008 for connecting to a near field antenna of the smart card for coupling inductively with a radio frequency, RF, H-field to provide an RF electrical signal in the smartcard.

The circuit also comprises a rectifier 20, 22, 24, 26, 1003. The rectifier 20, 22, 24, 26, 1003 comprises a first input capacitor 26, a second input capacitor 24, and a rectifying element 20. The first input capacitor 26 is connected in series with the input connection 1008. The second input capacitor is connected between a reference voltage connection and the input connection 1008. The rectifying element 20 is connected in a shunt configuration to the input connection 1008 via the input capacitor 26 to provide a one-way conduction path between the first input connection 1008 (via the first input capacitor 26) and the reference voltage connection, such as a ground e.g. a virtual ground. The series connection of the rectifying element 20 and the first capacitor 26 are thus connected in parallel with the second input capacitor 24. The rectifier also comprises a primary inductor 1003 connected, at one end, to the connection between the rectifying element 20 and the first input capacitor 26 and, at the other end, to an output of the rectifier 1002.

To split the RF electrical signal the circuitry of FIG. 5 also comprises a secondary inductor 1005, arranged for inductive coupling with the primary inductor 1003. The secondary inductor is coupled via a switching arrangement 280 to the chip 1009. The switching arrangement 280 comprises an RF switch 28 and may comprise matching elements 28-1, 28-2 which connect the RF switch 28 to the secondary inductor 1005 and to the chip 1009. As illustrated, matching element 28-1 connects the RF switch 28 to the chip 1009 and matching element 28-2 connects the RF switch 28 to the secondary inductor 1005.

The primary inductor 1003 and secondary inductor 1005 are mutually spatially arranged so that when the RF electrical signal flows in the primary inductor 1003 it induces a second alternating RF signal in the secondary inductor 1005. The inductive coupling between the two inductors 1003, 1005, provides an RF conduction path between the chip and the smartcard antenna thereby to enable the chip to perform near field RF communications via the smart card's antenna. The primary inductor 1003 and the secondary inductor 1005 may comprise laminar structures, for example tracks of conductive material carried on the substrate, such as printed coil inductors.

The switching arrangement 28 is coupled to the secondary inductor and is selectively operable to disable said provision of the RF electrical signal to the chip thereby to inhibit the chip from performing near field RF communications.

The output 1002 of the rectifier may be connected to power a voltage load such as the auxiliary circuit described above. In this particular splitter and rectifier, the splitter is provided by the coupling between the primary inductor, which may be part of the rectifier, and the secondary inductor. The structure illustrated in FIG. 5 also comprises an example of a switching circuit 28, such as that mentioned above with reference to FIG. 1 and FIG. 2. The switching circuits 28 described herein may be implemented in a variety of topologies.

In a first topology, an RF switch 280 is coupled to provide a controllable short circuit between the RF terminals of the chip 1009. The RF switch 280 of FIG. 5 has a first main connection having two terminals each of which are coupled to a corresponding one the RF terminals of the chip 1009. The RF switch 280 also has a second main connection having two terminals (e.g. 110-12 in FIG. 7) each of which are coupled to a corresponding one of the two ends of the secondary inductor 1005.

The RF switch 280 is selectively controllable to switch between a first state in which an RF electrical signal provided to the first main connection of the switch 280 is conducted to the second main connection and a second state in which the second main connection is decoupled from an RF electrical signal provided to the first main connection. In operation the RF switch can be held in the second state to prevent an RF electrical signal from being provided to the terminals of the chip.

Examples of appropriate RF switch arrangements are also described in the applicant's co-pending application GB2017273.0 the entire contents of which are hereby incorporated by reference.

Examples of near field RF communicators are defined in various standards for example ISO/IEC 18092 and ISO/IEC 21481 for NFC communicators, and ISO/IEC 14443 and ISO/IEC 15693 for near field RF communicators.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality described herein may be operated under computer control, such as may be provided by a programmable processor or other such control logic. This may be achieved using a general-purpose processor, which may be configured to perform a method according to any one of those described herein. In some examples such a controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller may comprise an analogue control circuit which provides at least a part of this control functionality. An embodiment provides an analogue control circuit configured to perform any one or more of the methods described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A near field RF communications enabled device comprising:
a coupler for connecting to a near field RF communications antenna for inductive coupling with an H-field provided from another near field RF communications enabled device in near field range,
an adaptive energy storage comprising a plurality of energy stores and a controller configured to control charging of the adaptive energy storage so that the plurality of energy stores are charged sequentially from energy obtained via the coupler;
wherein the controller is configured to provide, at the coupler, a signal configured to cause the another near field RF communications enabled device to increase or to maintain the H-field.

2-32. (canceled)
